(19) United States
(12) Patent Application Publication
(10) Pub. No.: US 2016/0355710 A1
(43) Pub. Date: Dec. 8, 2016

(54) NANOCRYSTALLINE CELLULOSE DERIVED FORMALDEHYDE-BASED ADHESIVE, USES THEREOF AND PROCESS FOR PREPARING SAME

(71) Applicant: CELLUFORCE INC, Montréal (CA)

(72) Inventors: Martin W. Feng, Vancouver (CA); Xiang-Ming WANG, Québec (CA); Yaolin ZHANG, Quebec (CA); Stéphan RAYMOND, Québec (CA); Richard BERRY, Notre-Dame de L'Ile Perrot (CA)

(21) Appl. No.: 15/117,650

(22) PCT Filed: Feb. 4, 2015
(86) PCT No.: PCT/CA2015/050080

§ 371 Date: Aug. 9, 2016

Related U.S. Application Data
(60) Provisional application No. 61/937,802, filed on Feb. 10, 2014.

(51) Int. Cl. C09J 161/30; C09J 161/24; C09J 161/28; C09J 161/06

(52) U.S. Cl. CPC C09J 161/30; C09J 161/06; C09J 161/24; C09J 161/28

(57) ABSTRACT

The present disclosure relates to a formaldehyde-based adhesive comprising Nanocrystalline Cellulose (NCC), a process for preparing same and uses thereof.

### BACKGROUND OF DISCLOSURE

Traditional lignocellulosic composites can be classified into four main groups based on raw material geometries: veneer-based, strand-based, particle-based and fiber-based materials. The veneer-based materials are used to manufacture plywood and laminated veneer lumber (LVL), the strand-based materials for waferboard and oriented strand board (OSB) for exterior applications, the particle-based materials for particleboard, and the fiber-based materials for medium density fiberboard (MDF), hardboard and low density fiberboard.

Wood adhesives are key components for manufacturing wood composite panels. Sellers (2001) reported that North America consumed more than 1 780 000 tons of wood adhesives (based on 100% solids content) in 1998, in which urea-formaldehyde (UF) and melamine-formaldehyde (MF) adhesives accounted for around 60% of the total consumption, and phenol-formaldehyde (PF) adhesives accounted for over 35%. Because of the subsequent release of formaldehyde from wood composites made with UF or melamine-urea-formaldehyde (MUF) adhesives, these adhesives are faced with increasingly more stringent regulations. As phenolic resins have better thermal resistance and weather resistance than amino adhesives, PF resins are commonly used for the manufacture of OSB and exterior grade plywood. They have also been used for particleboard and fiberboard manufacturing. Furthermore, PF resins are known to have very low formaldehyde emissions from their composites products throughout the service life.

For some products, a viscosity modifier such as wood flour is used to produce the right adhesive fluidity. Veneer type products, such as plywood, laminated veneer lumber, and glued laminated timber (glulam) and jointed wood products often require this addition to the formulation.

Nanocrystalline cellulose (NCC) is a crystalline particle that has a high intrinsic strength, nanometric dimensions and a surface that is populated with hydroxyl groups; NCC is in essence a nanoparticulate polyols. One example of cellulose nanocrystals is a sulphated cellulosic particle produced by sulphuric acid digestion of cellulose and being manufactured as CelluForce NCC™. The particles produced in this way are uniform and have an aspect ratio of about 20; the exact length and diameter of the particles are dependent upon the starting substrate and the process conditions that are used.

The International Standards Organisation (ISO) has stipulated that the use of the term cellulose nanocrystals (CNC), should replace nanocrystalline cellulose (NCC), however for the purpose of the present disclosure, the two can be used herein interchangeably.

### SUMMARY OF THE DISCLOSURE

In one aspect, there is provided a formaldehyde-based adhesive comprising:
NCC;
a formaldehyde-based resin and
a catalyst useful for polymerizing said formaldehyde-based resin.

In one aspect, there is provided a process for preparing a formaldehyde-based adhesive comprising mixing:
NCC;
a formaldehyde-based resin and
a catalyst useful for polymerizing said formaldehyde-based resin.

In a further aspect, there is provided a formaldehyde-based adhesive prepared in accordance with the process as defined herein.

In one aspect, there is provided a process for modulating at least one property of a formaldehyde-based adhesive, said method comprising adding NCC into a composition comprising a formaldehyde-based resin and a catalyst suitable for polymerizing said formaldehyde-based resin prior to allowing polymerization of said resin.

In a further aspect, there is provided a process for gluing one or more surfaces of wooden elements, comprising
applying the formaldehyde-based adhesive as defined herein on one or more surfaces of at least one of said wooden element;
contacting said surfaces of said wooden elements thereby forming an assembly with the adhesive situated between the surfaces;—curing said formaldehyde-based adhesive.

In a further aspect, there is provided a process for preparing a wooden composite comprising
contacting the formaldehyde-based adhesive as defined herein and a wooden material; and
curing said formaldehyde-based adhesive thereby forming said composite.

In one aspect, there is provided a process for producing a laminated wooden product, comprising
applying the formaldehyde-based adhesive as defined herein on one or more surfaces of at least one wood veneer;
contacting said surfaces of said wood veneers thereby forming an assembly with the adhesive situated between the surfaces; and
pressing and/or curing the wood veneers-adhesive assembly to produce said laminated wooden product.

In one aspect, there is provided a formaldehyde-based adhesive system comprising
NCC;
a formaldehyde-based resin and
a catalyst useful for polycondensing said formaldehyde-based resin;
   wherein 1) each of said NCC, resin and catalyst are in separate packages or 2) two or more of said NCC, resin and catalyst (preferably the NCC and resin together) are combined in one package.

In one aspect, there is provided a use of the formaldehyde-based adhesive as defined herein for gluing wooden materials.

In one aspect, there is provided a use of NCC for decreasing or substantially eliminating an amount of a wood flour or equivalent component thereof in a formaldehyde-based adhesive composition.

In one aspect, there is provided a use of NCC for modulating at least one property of a formaldehyde-based adhesive.

In one aspect, there is provided an article prepared from the formaldehyde-based adhesive as defined herein.

### DETAILED DESCRIPTION

A new approach to changing the properties of formaldehyde-based adhesives is being made possible by the introduction of NCC to formaldehyde-based adhesive formulations. It has also been observed that an amount of the wood flour or equivalent component can be decreased or eliminated by the addition of NCC. Wood flour is a generic term for a material used at several weight percent of the adhesive solids for viscosity modification. Some of the materials that are used in this way are corncob flour, wheat flour, Alder bark flour and sodium carbonate.

An embodiment is therefore in a use of NCC for decreasing or substantially eliminating an amount of a wood flour or equivalent component thereof in a formaldehyde-based adhesive composition that is using a rheological modifier such as wood flour. All aspects and embodiments described herein, including composition of matter and methods, can incorporate the above feature.

NCC can be incorporated at very small concentrations into formaldehyde-based adhesive formulations to allow the removal of an amount or all of the wood flour or equivalents to achieve valuable modulations in properties of the adhesive, in the process of applying the adhesive and in the resulting product containing the adhesive.

For example, as will be described below, replacing X % wood flour with 0.05*X % NCC allows:

1) RF Press Cycle-Time Reduction:

In one type of operation, wood is processed and then fed to a glue-line and assembly area and cured in an RF press. The press is often a production constraint within an operation.

In one type of operation, cycle times through the RF press with a glue formulation using NCC have been improved from 165 seconds to 145 seconds, or 12%. This improvement allows a significant labour cost and energy cost per m² reduction, and the potential for additional revenues and profitability through sales of high-margin product. In one operation, the rate of production was improved by 9.3 m² per hour.

2) Wet Strength and Dry Strength Improvement:

In the operation where the increase in production rate was obtained, 100% of the production samples experienced wood failure rather than adhesive failure in both dry strength and wet-strength tests showing that the glue-wood bond was stronger than the wood internal structure.

3) Glue Consumption Reduction:

As measured by weight per sq ft of production, the increase in production is accompanied by a decrease in glue consumption of 10%.

4) Viscosity Stability and Uniformity Improvement:

The traditional glue formulation using a wood flour or equivalent increases in viscosity over-time and becomes tacky, requiring operator intervention, whereas the viscosity of the NCC glue formulation remains consistent from start to finish. As with any manufacturing process, consistent inputs into the process are desirable.

5) Cleanability Improvement:

Cleaning equipment at the gluing station is an essential task at the end of the production day. The traditional glue formulation using a wood flour or equivalent generates significant waste (cleaning materials), and requires clean-up time measured in hours. Observations from production are that the clean-up generates far less waste and clean-up time is measured in minutes.

6) Employee Satisfaction Improvement:

Early indications are that employees are favourable to the NCC adhesive formulation. The glue is less tacky and easier to clean, saving time, energy, and discomfort. Employee buy-in is an important element to implementing change.

For example, as will be described below, the replacement of wood flour or equivalents with certain amounts of NCC decreased the amount of time needed to heat the wood-adhesive composite to the temperature required for the polymerisation of the adhesive formulation. It has been found that there is an optimum concentration which is below 1% by weight allows the removal of the greater than 5% of wood flour or equivalent that is needed to control the viscosity of the adhesive formulation so that it forms an adhesive layer that is of the correct thickness and uniformity for a good adhesive bond.

The replacement with NCC is believed to overcome the incomplete impregnation of the traditional wood flour component with the adhesive resin which causes changing viscosity during the time needed for application of the adhesive formulation. The improved consistency over time allows for improved adhesive coverage which provides higher strength and decreases glue use. Higher wet and dry strength are also achieved through the interaction of NCC with the adhesive formaldehyde-based resin components and this compliments the higher wet and dry strength obtainable from better production uniformity.

In certain embodiments, the amount of NCC is preferably less than about 1.0% w/w based on the total weight of the resin, preferably less than about 0.5%, less than about 0.4%, less than about 0.3%, less than about 0.2%, or preferably less than about 0.1% w/w. The amount will be determined by amount of replacement of wood flour or equivalent and the resin formulation used.

As used herein, a “resin” is contemplated as being the uncured formaldehyde-based component.

Formaldehyde-based resins, for example urea-formaldehyde resins, can be grouped by their average molar mass and the content of different functional groups. A number of formaldehyde-based resins can be obtained from commercial sources. It is possible to modify the synthesis conditions of the resins which will result in designing various possibilities for the structure and resin properties. It is contemplated that the present disclosure extend to all of such resins. Examples of formaldehyde-based resins include phenol-formaldehyde (PF) resins, cresol-/resorcinol-formaldehyde resins, urea-formaldehyde (UF) resins, melamine-formaldehyde (MF) resins, melamine-urea-formaldehyde (MUF) resins and mixtures thereof.

The properties of the adhesive can also be influenced by resin formulation and in particular the amounts of urea or melamine or both or phenol and formaldehyde as well as catalysts. Urea and melamine can also be used with formaldehyde to produce a resin formulation to be applied in an adhesive. Urea and melamine can also be used together in different ratios with formaldehyde to change properties of the resulting product. Phenol can also be used with formaldehyde to form Phenol-formaldehyde resins.

Catalysts used to prepare formaldehyde based adhesive formulations are well known in the art. In one embodiment, the catalyst is ammonium chloride.

In one embodiment, the formaldehyde-based adhesive as defined herein is comprising less than 5% w/w of wood flour or equivalent based on the total amount of the resin, preferably less than about 4%, preferably less than about 3%, preferably less than about 2%, preferably less than about 1%, or more preferably substantially no wood flour or equivalent. As used herein, “substantially no wood flour or equivalent” is intended to mean that no wood flour or equivalent is present as a result of deliberate addition to the resin or adhesive.

In one embodiment, the process for preparing said formaldehyde-based adhesive is comprising:

(i) providing a dispersion of NCC in water or an aqueous solvent;

(ii) adding said formaldehyde-based resin and said catalyst to the dispersion of (i); and

(iii) mixing the mixture of step (ii) to allow polymerization.

In one embodiment, step (ii) is comprising adding said formaldehyde-based resin and mixing for a period of time sufficient to obtain uniformity followed by adding said catalyst.

A use of these formaldehyde-based adhesive formulations is especially interesting in the wood products industry where an amount of the wood flour or equivalent component used for viscosity modification can be decreased or eliminated by the addition of NCC. As such, products using wood flour could benefit from its replacement by an amount of NCC. Possible applications may be in the manufacture of, for example, plywood, laminated veneer lumber (LVL), finger jointed lumber and glued laminated timber (glulam). It is also contemplated that other uses include for strand-based materials, for waferboard and oriented strand board (OSB) for exterior applications, particle-based materials for particleboard, and fiber-based materials for medium density fiberboard (MDF), hardboard and low density fiberboard.

The laminated or composite products resulting from the present invention provides modified/modulated physical and mechanical properties and production utility that may be achieved from an existing or novel formaldehyde-based adhesive composition.

In one embodiment, the process for gluing one or more surfaces of wooden elements, is a process for gluing wood veneers.

In one embodiment, the process for producing a laminated wooden product, is a process for producing a laminated veneer lumber.

In one embodiment, the process for producing a wooden composite is a process for producing a waferboard, oriented strand board (OSB), a particleboard, or a fiberboard including medium density fiberboard (MDF), hardboard and low density fiberboard.

The improvements provided by this disclosure will be valuable in the full range of formaldehyde based adhesives, preferably where a viscosity modifier is required.

In the following examples, it has been observed that the addition of a small amount of nanocrystalline cellulose improved one or more mechanical properties and the production utility of the formaldehyde based adhesive. Other properties such as physical properties including the viscosity or thixotropicity or mechanical properties such as hardness, impact resistance or a combination thereof could be modulated by the addition of nanocrystalline cellulose.

The following examples are provided to further illustrate details for the preparation and use of the formaldehyde-based adhesive products. They are not intended to be limitations on the scope of the instant disclosure in any way, and they should not be so construed. Those skilled in the art will readily understand that known variations of the conditions and processes of the following preparative procedures can be used.

Unless otherwise specified, the chemicals were used as received. One of the melamine-urea formaldehyde systems was obtained from Tembec. NCC is prepared by CelluForce™ by sulfuric acid hydrolysis of kraft bleached softwood pulp. The catalyst was also obtained from Tembec. The woods used were hard maple, American birch, American beech and American red maple with lengths between joints varying between 1 and 3 meters. The height and width of the wood pieces were 3.5 cm in height or thickness and 2.3 cm in width. It is understood that the amount of resin used can be adapted by the skilled person. For example, in the example below, about 29 to 31 kg/100 m² was used. The glue loading is liquid basis and the solid content is about 55 to 60%. In other applications, such as laminated veneer lumber with PF resin, it would be possible to use about 17 to 22 kg/m² with solid content of about 45 to 55%.

### Example 1: Increase in Production Process for Preparing Laminated Veneer Lumber for Truck and Trailer Beds

The process, in one configuration, bonds wood veneers with a wood adhesive formulation that is spread over the joining surfaces and then pressed and cured by the application of radio frequency heating. The glue mix used 45 kg of MUF resin and 0.16 kg of NCC 1.2 kg of ammonium chloride in 16 L of water. The NCC and water were premixed and the MUF resin and ammonium chloride were added separately to this suspension and mixed for 5 minutes after each addition.

The results in Table I show that the replacement of wood flour with NCC decreases the time-to-temperature from 165 seconds to 145 seconds.

TABLE I
Summary of the change in time to temperature during
production of a laminated veneer lumber board system

| | Wood flour, | NCC, | Time-to-temperature, |
|---|---|---|---|
| Formulation | weight % | weight % | Seconds |
| Melamine-Urea- | 5 | 0 | 165 |
| Formaldehyde | | | |
| Melamine-Urea- | 0 | 0.4 | 145 |
| Formaldehyde | | | |

### Example 2: Dry Shear Strength

Wood veneers were selected for uniformity based on density and grain orientation. Panels were made with a consistent formulation of melamine-urea-formaldehyde where the MUF was 57.5% of the solids and the catalyst (ammonium chloride) was 1.4% of the solids. The amounts of wood flour and NCC were varied as shown in Table II.

The results show that the dry shear strength, measured by standard test CSA 122-06, is decreased when a small amount of NCC is added and when the amount of wood flour is not changed. This decrease is caused by a substantial increase in viscosity which changes the flow uniformity of the adhesive. When all the wood flour is replaced with 0.41% NCC, the dry shear strength is increased (Rows 4 and 5) beyond that of the control (Row 1).

TABLE II
The change in dry shear strength caused by changes in the
amounts of wood flour and NCC.

| | Wood flour, | NCC, | Dry Shear, |
|---|---|---|---|
| Formulation | weight % | weight % | Mpa |
| Melamine-Urea- | 5.75 | 0 | 20.7 |
| Formaldehyde | | | |
| Melamine-Urea- | 5.75 | 0.18 | 19.8 |
| Formaldehyde | | | |
| Melamine-Urea- | 0 | 0.29 | 19.8 |
| Formaldehyde | | | |
| Melamine-Urea- | 0 | 0.41 | 23.0 |
| Formaldehyde | | | |
| Melamine-Urea- | 0 | 0.41 | 21.5 |
| Formaldehyde | | | |

### Example 3: Wet Shear Strength

Wood veneers were selected for uniformity based on density and grain orientation. Panels were made with a consistent formulation of melamine-urea-formaldehyde where the MUF was 57.5% of the solids and the catalyst (ammonium chloride) was 1.4% of the solids. The amounts of wood flour and NCC were varied as shown in Table III.

The results show that, as with the dry shear, the wet shear strength, measured by standard test Fruehauf Engineering Standard (FES) 32, is decreased when a small amount of NCC is added and when the amount of wood flour is not changed. When all the wood flour is replaced with as little as 0.29% NCC, the wet shear strength is increased (Rows 3, 4 and 5) beyond that of the control (Row 1).

TABLE III
The change in wet shear strength caused by changes in the
amounts of wood flour and NCC.

| | Wood flour, | NCC, | Wet Shear, |
|---|---|---|---|
| Formulation | weight % | weight % | Mpa |
| Melamine-Urea- | 5.75 | 0 | 10.3 |
| Formaldehyde | | | |
| Melamine-Urea- | 5.75 | 0.18 | 9.5 |
| Formaldehyde | | | |
| Melamine-Urea- | 0 | 0.29 | 11.4 |
| Formaldehyde | | | |
| Melamine-Urea- | 0 | 0.41 | 10.6 |
| Formaldehyde | | | |
| Melamine-Urea- | 0 | 0.41 | 11.6 |
| Formaldehyde | | | |

1. A formaldehyde-based adhesive comprising:
NCC;
a formaldehyde-based resin, and
a catalyst useful for polymerizing said formaldehyde-based resin;
wherein said adhesive is comprising less than 5% w/w of added wood flour or equivalent based on the total amount of the resin.

2. The adhesive of claim 1, wherein the amount of NCC is less than about 1.0% w/w based on the total weight of the resin.

3. The adhesive of claim 2, wherein the amount of NCC is less than about 0.5%.

4. The adhesive of claim 1, wherein the formaldehyde-based resin is a phenol-formaldehyde (PF) resin, a cresol-/resorcinol-formaldehyde resin, a urea-formaldehyde (UF) resin, a melamine-formaldehyde (MF) resin, a melamine-urea-formaldehyde (MUF) resin or a mixture of two or more thereof.

5. The adhesive of claim 4, wherein the formaldehyde-based resin is a phenol-formaldehyde (PF) resin.

6. The adhesive of claim 4, wherein the formaldehyde-based resin is a urea-formaldehyde (UF) resin.

7. The adhesive of claim 4, wherein the formaldehyde-based resin is a melamine-formaldehyde (MF) resin.

8. The adhesive of claim 4, wherein the formaldehyde-based resin is a melamine-urea-formaldehyde (MUF) resin.

9. The adhesive of claim 1, wherein the catalyst is ammonium chloride.

10. The adhesive of claim 1, wherein said adhesive is comprising substantially no added wood flour or equivalent thereof.

11. A process for preparing a formaldehyde-based adhesive comprising mixing:
NCC;
a formaldehyde-based resin and
a catalyst useful for polymerizing said formaldehyde-based resin;
wherein said adhesive is comprising less than 5% w/w of added wood flour or equivalent based on the total amount of the resin.

12. The process of claim 11, said process comprising:
(i) providing a dispersion of NCC in water or an aqueous solvent;
(ii) adding said formaldehyde-based resin and said catalyst to the dispersion of (i); and
(iii) mixing the mixture of step (ii) to allow polymerization.

13. The process of claim 12, said process comprising:
(i) providing a dispersion of NCC in water;
(iia) adding said formaldehyde-based resin to the result of step (i) and mixing for a period of time sufficient to obtain uniformity;
(iib) adding said catalyst to the result of step of (iia); and mixing for a period of time sufficient to obtain uniformity;
(iii) mixing the mixture of step (iib) to allow polymerization.

14. The process of claim 13, wherein said mixing in steps (iia) and/or (iib) is for about 5 minutes.

15-18. (canceled)

19. A method for decreasing or substantially eliminating an amount of a wood flour or equivalent component thereof in a formaldehyde-based adhesive composition, comprising adding an amount of NCC to said adhesive, wherein said adhesive is comprising less than 5% w/w of added wood flour or equivalent based on the total amount of the resin.

20. The method of claim 19, wherein said adhesive is comprising substantially no added wood flour or equivalent thereof.

21. The method of claim 20, wherein the amount of NCC is less than about 1.0% w/w based on the total weight of the resin.

22-23. (canceled)

24. The adhesive of claim 1, comprising:
NCC;
a formaldehyde-based resin, wherein the formaldehyde-based resin is a phenol-formaldehyde (PF) resin, a cresol-/resorcinol-formaldehyde resin, a urea-formaldehyde (UF) resin, a melamine-formaldehyde (MF) resin, a melamine-urea-formaldehyde (MUF) resin or a mixture of two or more thereof, and
a catalyst useful for polymerizing said formaldehyde-based resin;
wherein said adhesive is comprising less than 5% w/w of added wood flour or equivalent based on the total amount of the resin; and
wherein said adhesive is comprising substantially no added wood flour or equivalent thereof.

25. The process of claim 13, wherein said formaldehyde-based resin is a phenol-formaldehyde (PF) resin, a cresol-/resorcinol-formaldehyde resin, a urea-formaldehyde (UF) resin, a melamine-formaldehyde (MF) resin, a melamine-urea-formaldehyde (MUF) resin or a mixture of two or more thereof;
wherein said catalyst is ammonium chloride; and
wherein the amount of NCC is less than about 1.0% w/w based on the total weight of the resin.
